(19) United States
(12) Patent Application Publication
(10) Pub. No.: US 2006/0293890 A1
(43) Pub. Date: Dec. 28, 2006

(54) Speech recognition assisted autocompletion of composite characters

(75) Inventors: Colin Blair, Westleigh (AU); Kevin Chan, Ryde (AU); Christopher R. Gentle, Gladesville (AU); Neil Hepworth, Artarmon (AU); Andrew W. Lang, Epping (AU)

Correspondence Address: SHERIDAN ROSS P.C., 1560 BROADWAY, SUITE 1200, DENVER, CO, 80202, US

(73) Assignee: Avaya Technology Corp., Basking Ridge, NJ (US)

(21) Appl. No.: 11/170,302

(22) Filed: Jun. 28, 2005

(51) Int. Cl. G10L 15/26

(52) U.S. Cl. 704/235

(57) ABSTRACT

Speech recognition assisted autocompletion of textual composite words or characters (i.e. words or characters containing a number of components) is provided. In response to user input specifying a component of a word or character, a list of candidate words or characters is generated. The desired word or character can be selected, or the list of candidate words or characters can be narrowed, in response to the user speaking the desired word or character. As a result, entry of words or characters formed from a number of letters, strokes, or word shapes is facilitated by user input comprising a combination of a specification of a component of the desired word or character and speech corresponding to a pronunciation of the desired word or character.

### FIELD OF THE INVENTION

The present invention is directed to the entry of composite characters. In particular, the present invention facilitates the entry of words or characters into communications or computing devices by combining manual user input and speech recognition to narrowly tailor lists of candidate words or characters.

### BACKGROUND

Mobile communication and computing devices that are capable of performing a wide variety of functions are now available. Increasingly, such functions require or can benefit from the entry of text. For example, text messaging services used in connection with cellular telephones are now in widespread use. As a further example, portable devices are increasingly used in connection with email applications. However, the space available on portable devices for keyboards is extremely limited. Therefore, the entry of text into such devices can be difficult. In addition, the symbols used by certain languages can be difficult to input, even in connection with larger desktop communication or computing devices.

In order to facilitate the entry of words or characters, particularly using the limited keypad of a portable telephone or other device, autocompletion features are available. Such features can display a list of candidate words or characters to the user in response to receiving an initial set of inputs from a user. These inputs may include specification of the first few letters of a word, or the first few strokes of a character, such as a Chinese character. However, because the resulting list can be extremely long, it can be difficult for a user to quickly locate the desired word or character.

In order to address the problem of having a long list of auto complete candidates, systems are available that provide a list in which the candidate words or characters are ranked according to their frequency of use. Ranking the candidates according to their frequency of use can reduce the need for the user to scroll through the entire list of candidates. However, it can be difficult to order a list of candidate words or characters in a sensible fashion. In addition, where the user is seeking an unusual word or character, little or no time-savings may be realized.

As an alternative to requiring manual input from a user, voice or speech recognition systems are available for entering text or triggering commands. However, the accuracy of such systems often leaves much to be desired, even after user training and calibration. Furthermore, a full-featured voice recognition system often requires processing and memory resources that are not typically found on mobile communication or computing devices, such as cellular telephones. As a result, speech recognition functions available in connection with mobile devices are often rudimentary, and usually geared towards recognizing a narrow subset of the spoken words in a language. Furthermore, speech recognition on mobile devices is often limited to triggering menu commands, such as accessing an address book and dialing a selected number.

### SUMMARY

The present invention is directed to solving these and other problems and disadvantages of the prior art. In accordance with embodiments of the present invention, speech recognition is used to filter or narrow a list of candidate composite characters, such as words (for example in connection with English language text) or characters (for example in connection with Chinese text). In particular, following a user's manual input of a letter, stroke or word shape of the word or character being entered, the user may speak that character. Speech recognition software then attempts to eliminate words or characters from the candidate list that sound different from the spoken word or character. Accordingly, even a relatively rudimentary speech recognition application can be effective in at least eliminating some words or characters from the candidate list. Furthermore, by first providing a letter, stroke or other component of a word or character through a selection or input of that component, the range of available or candidate words or characters is more narrowly defined, which can reduce the accuracy required of the speech recognition application in order to further narrow that range (i.e., narrow the candidate list) or positively identify the word or character that the user seeks to enter.

### BRIEF DESCRIPTION OF THE DRAWINGS

FIG. 1 is a block diagram of components of a communication or computing device in accordance with embodiments of the present invention;

FIG. 2 depicts a communication device in accordance with embodiments of the present invention;

FIG. 3 is a flowchart depicting aspects of the operation of a speech recognition assisted autocompletion process in accordance with embodiments of the present invention; and

FIGS. 4A-4D depict example display outputs in accordance with embodiments of the present invention.

### DETAILED DESCRIPTION

In accordance with embodiments of the present invention, a word or character may be included in a list of words or characters (collectively referred to herein as “characters”) available for selection by a user in response to user input indicating that a particular component of a word or character, such as a letter (for example in the case of an English word) or a stroke or word shape (for example in the case of a Chinese character), is included in the desired character. In addition, the list of characters can be narrowed in response to speech input from the user. In particular, in response to the receipt of speech input from the user that can be used to identify characters in the candidate list that are associated (or not) with the received speech, the content of the candidate list is altered. Accordingly, entry of characters is facilitated by providing a shorter list of candidate words or characters, or by the identification of an exact character, through the combined use of a component of the desired character input by a user, and speech recognition that receives as input the user's pronunciation of the desired character.

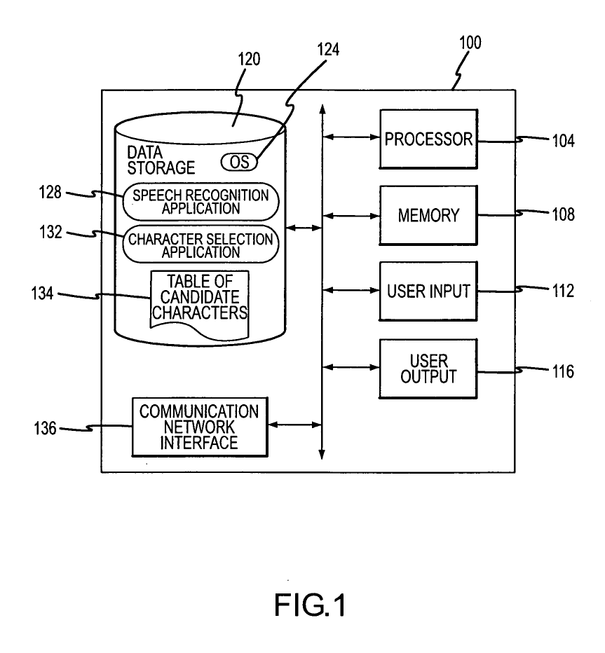

With reference now to FIG. 1, components of a communications or computing device 100 in accordance with embodiments of the present invention are depicted in block diagram form. The components may include a processor 104 capable of executing program instructions. Accordingly, the processor 104 may include any general purpose programmable processor or controller for executing application programming. Alternatively, the processor 104 may comprise a specially configured application specific integrated circuit (ASIC). The processor 104 generally functions to run programming code implementing various functions performed by the communication or computing device 100, including word or character selection operations as described herein.

A communication or computing device 100 may additionally include memory 108 for use in connection with the execution of programming by the processor 104 and for the temporary or long term storage of data or program instructions. The memory 108 may comprise solid state memory resident, removable or remote in nature, such as DRAM and SDRAM. Where the processor 104 comprises a controller, the memory 108 may be integral to the processor 104.

In addition, the communication or computing device 100 may include one or more user inputs 112 and one or more user outputs 116. Examples of user inputs 112 include keyboards, keypads, touch screen inputs, and microphones. Examples of user outputs 116 include speakers, display screens (including touch screen displays) and indicator lights. Furthermore, it can be appreciated by one of skill in the art that the user input 112 may be combined or operated in conjunction with a user output 116. An example of such an integrated user input 112 and user output 116 is a touch screen display that can both present visual information to a user and receive input selections from a user.

A communication or computing device 100 may also include data storage 120 for the storage of application programming and/or data. In addition, operating system software 124 may be stored in the data storage 120. The data storage 120 may comprise, for example, a magnetic storage device, a solid state storage device, an optical storage device, a logic circuit, or any combination of such devices. It should further be appreciated that the programs and data that may be maintained in the data storage 120 can comprise software, firmware or hardware logic, depending on the particular implementation of the data storage 120.

Examples of applications that may be stored in the data storage 120 include the speech recognition application 128 and word or character selection application 132. In addition, the data storage 120 may contain a table or database of candidate words or characters 134. As described herein, a speech recognition application 128, character selection application 132 and/or table of candidate words or characters 134 may be integrated with one another, and/or operate in cooperation with one another. The data storage 120 may also contain application programming and data used in connection with the performance of other functions of the communication or computing device 100. For example, in connection with a communication or computing device 100 such as a cellular telephone, the data storage may include communication application software. As another example, a communication or computing device 100 such as a personal digital assistant (PDA) or a general purpose computer may include a word processing application and data storage 120. Furthermore, according to embodiments of the present invention, a speech recognition application 128 and/or character selection application 132 may operate in cooperation with communication application software, word processing software or other applications that can receive words or characters entered or selected by a user as input.

A communication or computing device 100 may also include one or more communication network interfaces 136. Examples of communication network interfaces include cellular telephony transceivers, a network interface card, a modem, a wireline telephony port, a serial or parallel data port, or other wireline or wireless communication network interface.

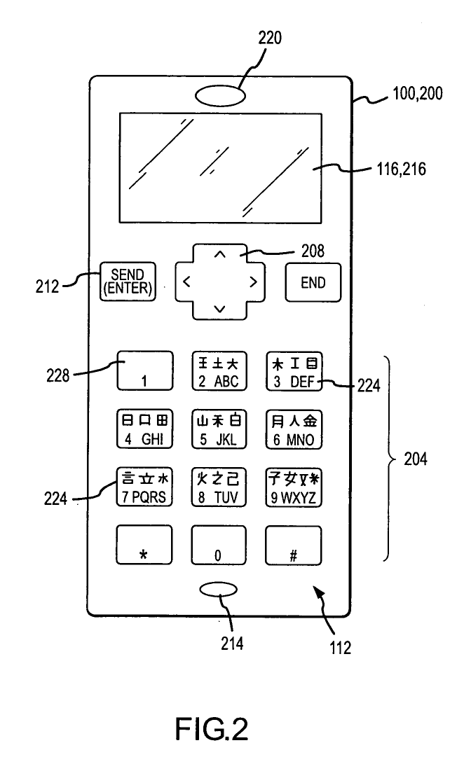

With reference now to FIG. 2, a communication or computing device 100 comprising a cellular telephone 200 is depicted. The cellular telephone 200 generally includes a user input 112 comprising a numeric keypad 204, cursor control button 208, enter button 212, and microphone 214. In addition, the cellular telephone 200 includes user outputs comprising a visual display 216, such as a color or monochrome liquid crystal display (LCD), and speaker 220.

When in a text entry or selection mode, a user can, in accordance embodiments with the present invention, cause a partial or complete list containing one or more words or characters to be displayed in the display screen 216, in response to input comprising specified letters, strokes or word shapes entered by the user through the keypad 204. As can be appreciated by one of skill in the art, each key included in the keypad may be associated with a number of letters or character shapes, as well as with other symbols. For instance, the keypad 204 in the example of FIG. 2 associates three (and sometimes 4) letters 224 with keys 2-9. In addition, the keypad 204 in the example of FIG. 2 associates three (and in one case four) Chinese root radical categories 228 with keys 2-9. As can be appreciated by one of skill in the art, such root radicals may be selected in connection with specifying the shapes comprising a complete Chinese character, for example using the wubizixing shape based method for continuing Chinese characters. In addition, selection of one of the root radicals can make available related radicals to allow the user to specify a desired word shape with particularity. Accordingly, a user may select a letter or word shape associated with a particular key included in the keypad 204 by pressing or tapping the key associated with a desired letter or word shape multiple times.

The list of candidate characters created as a result of the selection of letters or word shapes is displayed, at least in part, by the visual display 216. If the list is long enough that it cannot all be conveniently presented in the display 216, the cursor button 208 or some other input 112 may be used to scroll through the complete list. The cursor button 208 or other input 112 may also be used in connection with the selection of a desired character, for example by highlighting the desired character in a displayed list using the cursor button 208 or other input 112, and then selecting that character by, for example, pressing the enter button 212. In addition, as described herein, the list of candidate characters can be narrowed based on speech provided by the user to the device 100 through the microphone 214 that is then processed by the device 100, for example, through the speech recognition application 128. Furthermore, the speech recognition application 128 functions in cooperation with the character selection application 132 such that the speech recognition application 128 tries to identify characters included in a list generated by the character selection application 132 in response to manual or other user input specifying a component of the desired character, rather than trying to identify all words that may be included in the speech recognition application 128 vocabulary.

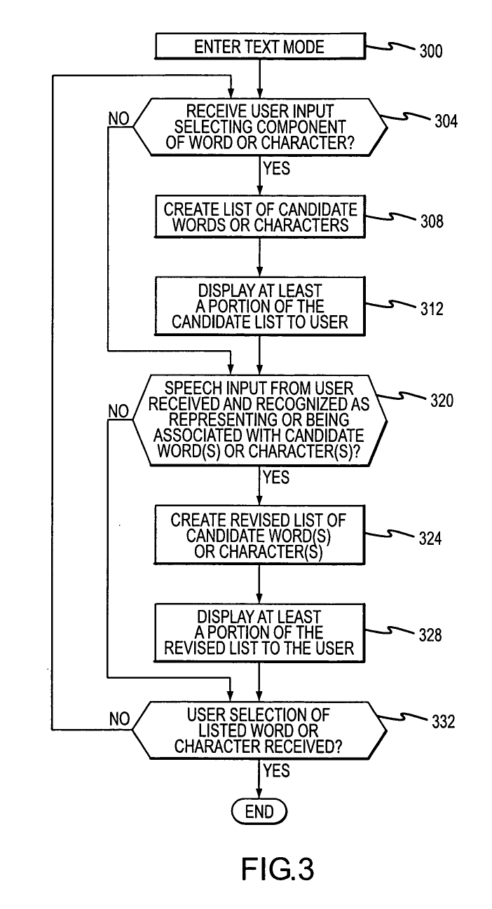

With reference now to FIG. 3, aspects of the operation of a communications or computing device 100 providing speech recognition assisted autocompletion of characters, such as English language words or Chinese language characters in accordance with embodiments of the present invention are illustrated. Initially, at step 300, the user enters or selects a text entry mode. For example, where the device 100 comprises a cellular telephone 200, a text entry mode may comprise starting a text messaging application or mode. At step 304, a determination is made as to whether user input is received in the form of a manual selection of a component (e.g., a letter, stroke, or word shape) of a word or character. In general, embodiments of the present invention operate in connection with receipt of such input from the user to create the initial list of candidate characters. After receiving selection of a component of a character, a list of candidate characters containing the selected component is created (step 308). At least a portion of the candidate list is then displayed to the user (step 312). As can be appreciated by one of skill in the art, the list of candidate characters can be quite long, particularly when only a single component is specified. Accordingly, the display, such as the liquid crystal display 216 of a cellular telephone 200, may be able to display only a small portion of the candidate list. Where only a portion of the candidate list can be displayed at any one time, the user may scroll through that list to search for the desired character.

The user may then choose to narrow the candidate list by providing speech input. Accordingly, a determination may then be made as to whether speech input from the user is received and recognized as representing or being associated with a pronunciation of a candidate character (step 320). In particular, speech received, for example through a microphone 214, is analyzed by the speech recognition application 128, to determine whether a match with a candidate character can be made. If a match can be made, a revised list of candidate characters is created (step 324). As can be appreciated by one of skill in the art, even a rudimentary speech recognition application 128 may be capable of positively identifying a single character from the list, particularly when the list has been bounded through the receipt of one or more components that are included in the character that the user wishes to enter. As can also be appreciated by one of skill in the art, a speech recognition application 128 may be able to reduce the size of a list of candidate characters, even if a particular character cannot be identified from that list. For example, where the speech recognition application 128 is able to associate speech input by the user with a subset of the list of candidate characters, the revised list may comprise that subset of characters. Accordingly, a speech recognition application 128 may serve to eliminate from a list of candidates those words or characters that have a spoken sound that is different from the spoken sound of the desired word or character. Accordingly, the number of candidates that a user must (at least at this point) search in order to find a desired word or character is reduced. At least a portion of the revised list is then displayed to the user (step 328). Should the revised list contain too many candidates to be displayed by a user output 116, such as a liquid crystal display 216, simultaneously, the user may again scroll through that list.

At step 332, a determination may again be made as to whether the user has selected one of the candidate characters. This determination may be made either after it is determined that the user has not provided speech in order to produce the list of candidate characters, or after creating a revised list of candidate list of characters at step 328. If the user has selected a listed character, the process ends. The user may then exit the text mode or begin the process of selecting a next character.

If the user has not yet selected a listed character, the process may return to step 304, at which point the user may enter an additional component, such as an additional letter, stroke or word shape. The list of characters that may then be created at step 308 comprises a revised list of characters to reflect the additional component that has now been specified by the user. For instance, where a user has specified two letters or word shapes, those letters or word shapes may be required in each of the candidate characters. The resulting list may then be displayed, at least in part (step 312). After displaying the revised list to the user at step 312, the user may make another attempt at providing speech input in order to further reduce the number of candidate characters in the list (step 320). Alternatively, if a selection of a listed character is not made by the user at step 332, the user may decide not to provide additional input in the form of an additional component of the desired composite character at step 312 and may instead proceed to step 320, to make another attempt at narrowing the list of candidates by providing speech input. If additional speech input is provided, that input may be used to create a revised list of candidate characters (step 324) and that revised list can be displayed at least in part, to the user (step 328). Accordingly, it can be appreciated that multiple iterations of specifying components of a word or character and/or providing speech to identify a desired word or character or to at least reduce the size of the list of candidates, can be performed.

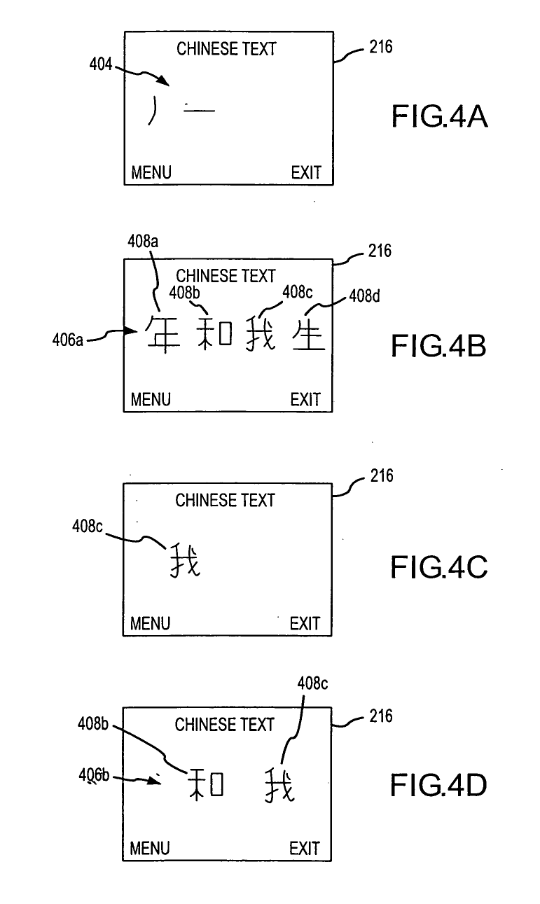

With reference now to FIGS. 4A-4C, examples of the visual output that may be provided to a user in connection with operation of embodiments of the present invention are depicted. In particular, the display screen 216 of a device 100 comprising a cellular telephone 200 in a Chinese language text entry mode is depicted. As shown in FIG. 4A, the user may select one or more strokes 404 of a desired character. The selection of strokes 404 may be performed by pressing those keys included in the keyboard 204 that are associated with the first strokes forming the character that the user desires to specify.

Because Chinese characters are formed from eight basic strokes, and because there are many thousands of Chinese characters in use, specifying two strokes of a desired character will typically result in the generation of a long list of candidate characters. A partial list 406a of candidate characters 408a-d that begin with the strokes 404 specified in the present example is illustrated in FIG. 4B. The first character 408a is pronounced roughly as “nin,” the second character 408b is pronounced roughly as “wo,” the third character is pronounced roughly as “ngo,” and the fourth character is pronounced roughly as “sanng.” From this list, the user may desire the third character 408c. In accordance with embodiments of the present invention, the user may make a selection from the candidate list by voicing the desired character. Accordingly, the user may pronounce the third character 408c, causing the list to be modified so as to contain only that character 408c, as shown in FIG. 4C. The user can then confirm that the speech recognition application 128 running on or in association with the cellular telephone 200 has correctly narrowed the list to that character by hitting the enter key 212, or otherwise entering a selection of that character. Therefore, it can be appreciated that in accordance with embodiments of the present invention the manual entry of components of a character and speech recognition work in combination to facilitate the selection by a user of a character comprised of a large number of strokes. Furthermore, this can be accomplished simply by entering at least one of those strokes and by then voicing the desired character. This combination is advantageous in that even if the speech recognition application 128 is not accurate enough to discern the desired character solely from the spoken sound of that character, it will likely be able to distinguish the vastly different sounds of similar looking characters.

Furthermore, even if the speech recognition software 128 is unable to discern the desired character from the spoken sound with reference to the list of candidate characters generated in response to one or more manually entered strokes, it should be able to narrow the list of candidate characters. For example, the speech recognition software 128 may not be able to discern between the second 408b (“wo”) and third 408c (“ngo”) characters based on the user's speech input while the list of candidate characters shown in FIG. 4B is active. However, that speech input should allow the speech recognition software 128 to eliminate the first 408a (“nin”) and fourth 408d (“sanng”) characters as candidates. Accordingly, through the combination of manual input and speech recognition of embodiments of the present invention, the list of candidates may be narrowed to the second 408b and third 408c characters, shown in FIG. 4D as list 406b. The user may then select the desired character from the narrowed list 406b by, for example, highlighting that character using the cursor control button 208 and pressing the enter key 212.

Although certain examples of embodiments of the present invention described herein have discussed using manual entry through keys in a keypad of one or more components of a desired word or character, and/or the selection of a desired word or character, embodiments of the present invention are not so limited. For example, manual entry may be performed by making selections from a touch screen display, or by writing a desired component in a writing area of a touch screen display. As a further example, the initial (or later) selection of a component or components of a word or character need not be performed through manual entry. For instance, a user may voice the name of the desired component to generate a list of words or characters that can then be narrowed by voicing the desired word or character. In addition, embodiments of the present invention have application in connection with the selection and/or entry of text in any language where the “alphabet” or component parts of words or symbols is beyond what can be easily represented on a normal communication or computing device keyboard.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with the various modifications required by their particular application or use of the invention. It is intended that the appended claims be construed to include alternative embodiments to the extent permitted by the prior art.

What is claimed is:

1. A method for specifying a written character, comprising:
receiving a selection of at least a first character component;
generating a first list of candidate characters containing said first selected component;
receiving first speech input from a user; and
using said first speech input from a user to modify said first list of candidate characters, wherein a second list of candidate characters is generated.

2. The method of claim 1, wherein said first speech input comprises speech corresponding to a pronunciation of a desired character.

3. The method of claim 2, wherein said desired character is included in said first list, and wherein said second list contains only said desired character.

4. The method of claim 2, wherein said modification to said first list comprises removing characters that do not correspond to said pronunciation of said desired character.

5. The method of claim 4, wherein said second list contains a number of candidate characters.

6. The method of claim 1, further comprising:
receiving a second speech input from a user, wherein said second list is modified, wherein a third list of candidate characters is generated.

7. The method of claim 1, further comprising:
receiving a selection of a second character component;
using said second selected component to modify said second list of candidate characters, wherein a third list of candidate characters is generated.

8. The method of claim 1, further comprising:
receiving a selection of one of said characters from said second list.

9. The method of claim 1, wherein said first character component comprises one of a first letter of an English language word and a first stroke of a Chinese language character.

10. The method of claim 9, further comprising:
receiving a selection of a second stroke of a Chinese language character, wherein said generating a first list comprises generating a first list of Chinese language characters containing said selected first and second strokes.

11. A device for facilitating selection of textual characters, comprising:
a user input, wherein a number of components of a desired character are available for selection, and wherein a pronunciation by a user of said desired character is received;
a memory, wherein said memory contains a table of characters; and
a processor, wherein in response to user input comprising at least a first component of a desired character said processor executes instructions to perform a look up in said table in said memory and to form a first list of candidate characters, and wherein in response to user input comprising a pronunciation of a desired character said processor executes instructions to modify said first list of candidate characters to form a second list of candidate characters containing characters determined to correspond to said pronunciation of a desired character

12. The device of claim 11, wherein said second list contains a single candidate character.

13. The device of claim 11, wherein said user input includes:
a first user input comprising a keypad; and
a second user input comprising a microphone.

14. The device of claim 11, wherein said user input comprises a microphone.

15. The device of claim 11, wherein in response to receipt of said pronunciation of said desired character said processor executes instructions comprising a speech recognition application, and wherein said modifying said first list of candidate characters includes at least one of: a) removing characters from said first list that are determined to not correspond to said pronunciation of said desired character, and b) maintaining characters in said first list that are determined to correspond to said desired character.

16. The device of claim 11, further comprising:
a user output, wherein at least a portion of said first list of candidate characters is provided to a user, and wherein at least a portion of said second list of candidate characters is provided to said user.

17. A device for selecting a character, comprising:
means for receiving input from a user;
means for storing associations of a plurality of characters with one or more character components;
means for storing an association between a character and a pronunciation of said character for a number of characters included in said plurality of characters;
means for generating a first list of candidate characters selected from said plurality of characters in response to user input comprising at least a first character component;
means for modifying said first list of candidate characters to form a second list of candidate characters in response to user input comprising a pronunciation of a desired character.

18. The device of claim 17, wherein said means for receiving input from a user includes means for receiving manual input from a user.

19. The device of claim 17, wherein said means for receiving input from a user includes means for receiving speech input from a user.

20. The device of claim 17, further comprising:
means for providing visual output to a user, wherein at least a portion of said first list of candidate characters is displayed.
